(19) United States
(12) Patent Application Publication
(10) Pub. No.: US 2024/0217822 A1
(43) Pub. Date: Jul. 4, 2024

(54) PROCESS AND SYSTEM FOR PREPARING FERRIC PHOSPHATE BY MIXING AND STIRRING IN REACTOR WITH EXTERNAL CIRCULATION

(71) Applicant: SHENZHEN BATIAN ECOTYPIC ENGINEERING CO., LTD., Shenzhen City (CN)

(72) Inventors: Deming Huang, Guizhou Province (CN); Deli Hao, Guizhou Province (CN); Jin Fang, Guizhou Province (CN); Guojun Zhao, Guizhou Province (CN); Faan Liu, Shenzhen City (CN); Jianqing Hua, Shenzhen City (CN)

(21) Appl. No.: 18/545,577

(22) Filed: Dec. 19, 2023

(30) Foreign Application Priority Data
Dec. 30, 2022 (CN) CN 2022117392940
Jun. 15, 2023 (CN) CN 2023107146889

(51) Int. Cl. C01B 25/37; B01F 27/112

(52) U.S. Cl. CPC C01B 25/375; B01F 27/112

(57) ABSTRACT

The present disclosure relates to the technical field of ferric phosphate, in particular to a process and a system for preparing ferric phosphate by mixing and stirring in a reactor with external circulation. Disclosed is a process for preparing ferric phosphate by mixing and stirring in a reactor with external circulation, comprising the following steps: adding a ferric salt solution, a monoammonium phosphate solution, and a protective agent into the reactor, and subjecting the resulting mixed liquid to a preliminary reaction at 90-100° C.; after the completion of the preliminary reaction, carrying out an external circulation reaction at 85-90° C. The process described in the present disclosure has a high reaction speed, and the obtained ferric phosphate has a high yield and low content of impurity in the ferric phosphate.

### CROSS-REFERENCE TO RELATED CASES

This application claims the benefit of Chinese patent application Serial No. 2022117392940 filed on Dec. 30, 2022, and Chinese patent application Serial No. 2023107146889 filed on Jun. 15, 2023, and incorporates such applications by reference into this disclosure as if fully set out at this point.

### FIELD OF THE INVENTION

The present disclosure relates to the technical field of ferric phosphate, in particular to a process and a system for preparing ferric phosphate by mixing and stirring in a reactor with external circulation.

### BACKGROUND OF THE INVENTION

There is a one-step method and a two-step method for the preparation of ferric phosphate. The one-step method involves precipitation and type transformation of ferric phosphate in the same reaction, where yellow ferric phosphate precipitates are first generated, and then converted to pinkish-white ferric phosphate at a high temperature above 90° C. The two-step method mainly involves generating the yellow ferric phosphate precipitates in the first reaction, and filtering and transferring them to another reaction, where a certain concentration of dilute phosphoric acid is added, and then converting to pinkish-white ferric phosphate at a high temperature above 90° C. The content of the impurity in ferric phosphate generated by the two-step method is low, especially the sulfur content can be reduced to tens of parts per million (ppm), but the two-step method has low reaction efficiency and is not conducive to industrial production.

The one-step method has a simple reaction process, but it has the disadvantage of low purity of the obtained ferric phosphate.

For this purpose, we provide a process and a system for preparing ferric phosphate by mixing and stirring in a reactor with external circulation.

### SUMMARY OF THE INVENTION

In order to overcome the shortcomings of the existing technology, the present disclosure provides a process and a system for preparing ferric phosphate by mixing and stirring in a reactor with external circulation.

To solve the technical problem, the technical solution of the present disclosure is as follow:
a process for preparing ferric phosphate by mixing and stirring in a reactor with external circulation, comprising the following steps of:
adding a ferric salt solution, a monoammonium phosphate solution, and a protective agent into the reactor, and subjecting the resulting mixed liquid to a preliminary reaction at 90-100° C.; after the completion of the preliminary reaction, carrying out an external circulation reaction at 85-90° C.

Furthermore, the time for the preliminary reaction is 1.5-2 h.

Furthermore, the time for the circulation reaction is 2-3 h.

Furthermore, a feeding port of the reactor is equipped with a feeding distributor which increases the contact of materials during the feeding process, allowing the reaction to be more complete.

Furthermore, a circulation pipeline is arranged outside the reactor, and a circulation pump is arranged on the circulation pipeline; by using the circulation pump, the mixed liquid is delivered from the reactor to the circulation pipeline, and then from the circulation pipeline to the reactor to form a circulation for external circulation reaction.

Furthermore, one end of the circulation pipeline is connected to the bottom of the reactor, and another end of the circulation pipeline is connected to the top of the reactor. The mixed liquid in the reactor can be circulated through the circulation pump to flow out from the bottom of the reactor and enter the reactor from the top of the reactor.

Furthermore, the circulation pump outside the reactor is a ceramic dispersion pump, which has a certain dispersing effect and can disperse the materials, thereby increasing the rate of the reaction after the materials entering the reactor.

Furthermore, the reactor is made of steel lined PE material. A double-layer heating coiler is provided inside the reactor, which, combined with the thermometers in the upper and lower layers, can uniformly control the temperature of the materials, ensuring consistent reaction conditions; a cooling coiler is provided outside the reactor, which is configured for heat exchange of the materials after the completion of the reaction, thereby improving production efficiency.

Furthermore, the stirring speed of the stirring paddle in the reactor is 800-900 r/min, and the delivery speed of the circulation pump is 50 m³/h.

Furthermore, the stirring paddle in the reactor has a hybrid direction.

Furthermore, the reactor has a slope at the bottom.

Furthermore, the protective agent is hydrogen peroxide.

In the present disclosure, a spoiler is arranged inside the reactor. When the stirring paddle with the hybrid direction is stirring, the reaction liquid forms a reverse flow after impacting the spoiler during stirring. The reaction liquid in the reverse flow and the reaction liquid impacting the spoiler can form turbulence, which can improve mixing and contact among various raw materials in the reaction liquid, and promote the reaction process.

In addition, after the completion of the preliminary reaction, a portion of the ferric phosphate precipitates and deposits at the bottom of the reactor with a slope. The portion of the ferric phosphate can be discharged through the discharge port arranged at the bottom of the reactor (i.e., arranged at the bottom of the opposite side of the circulation material outlet), which facilitates stirring.

During the circulation reaction, the operation of the circulation pump accelerates the mixing and contact between the reactants at the bottom of the reactor and the material liquid in the upper layer of the reactor, allowing the raw materials that have not yet come into contact with the reaction to fully contact and accelerate the reaction process.

A system for preparing ferric phosphates by mixing and stirring in a reactor with external circulation, including a controller for executing the process of preparing ferric phosphates by mixing and stirring in a reactor with as described above.

The beneficial effects of the present disclosure are as follow:
the process described in the present disclosure has a high reaction speed, and the obtained ferric phosphate has a high yield and low content of impurity in the ferric phosphate.

### BRIEF DESCRIPTION OF THE DRAWINGS

The present disclosure will be further described in conjunction with the accompanying drawings and embodiments.

FIG. 1 is a schematic diagram of a reactor and a circulation pipeline involved in a circulation process according to one or more embodiments of the present disclosure;

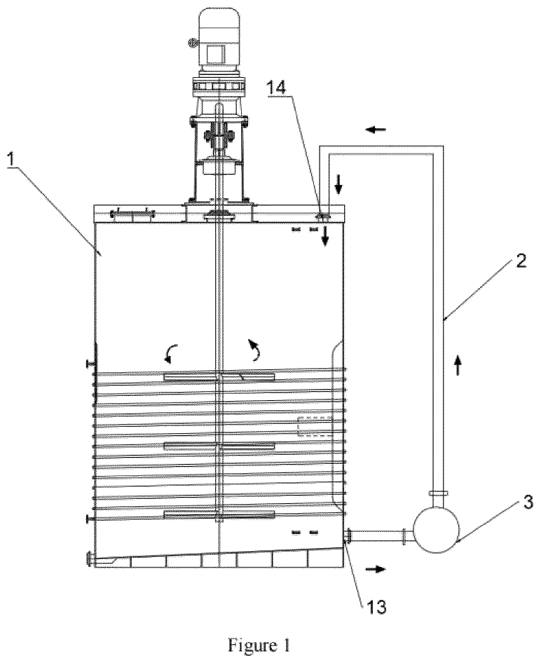

FIG. 2 is a schematic diagram of the reactor involved in the circulation process according to one or more embodiments of the present disclosure;

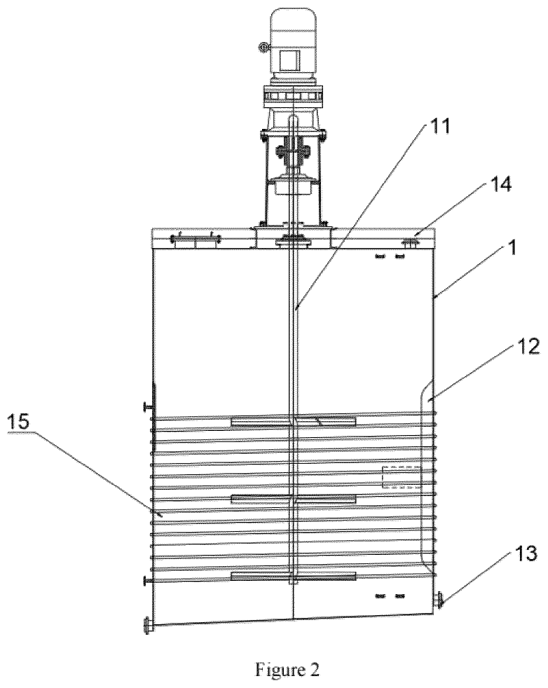

FIG. 3 is a schematic diagram of the internal structure of the reactor involved in the circulation process according to one or more embodiments of the present disclosure, wherein:

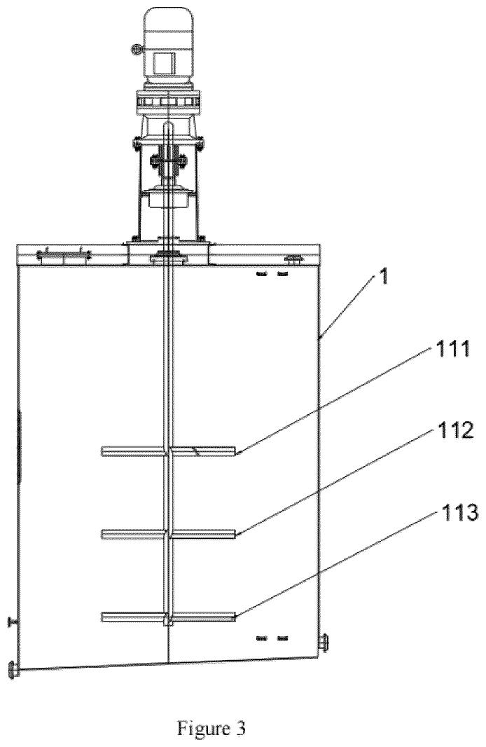

1 is a reactor; 2 is a circulation pipeline; 3 is a circulation pump; 11 is a stirring paddle; 12 is a spoiler; 13 is a circulation material outlet; 14 is a circulation material inlet; 15 is a jacket; 111 is a set of upper branch blades; 112 is a set of middle branch blades; 113 is a set of lower branch blades.

### DETAILED DESCRIPTION OF THE PREFERRED EMBODIMENTS

In order to facilitate comprehension for those skilled in the art, the present disclosure will be further described in conjunction with embodiments, and the content mentioned in the embodiments should not be construed to limit the present disclosure.

As used herein, the term “and/or” includes any combination of items associated with one or more listed items. The terms used herein are only for describing specific embodiments and are not intended to limit the present disclosure. As used herein, the singular forms “a”, “an”, and “the” are also intended to include the plural form, unless the context explicitly indicates otherwise. It is further understood that, the term “comprise” when used in this specification, specifies the stated features, integers, steps, operations, elements, and/or compositions, but does not exclude the existence or addition of one or more other features, integers, steps, operations, elements, compositions, and/or their combinations.

Unless otherwise defined, all terms used herein (including technical and scientific terms) have the same meanings commonly understood by those skilled in the art to which the present disclosure belongs. It is further understood that, terms (such as those defined in commonly used dictionaries) are interpreted in a manner consistent with their meanings in the context of the relevant field and are not idealized or overly formal, unless explicitly defined herein.

The exemplary embodiments described herein may appropriately lack limitations of any one or more elements, and is not specifically disclosed here. Therefore, the terms “include”, “comprise”, “contain” and the like should be understood broadly and non-restrictively. In addition, the expressions of the terms used herein are used for description without limitation, and the use of these expressions of the terms that do not include any equivalent features is unintentional, only describing a portion of their features. However, according to the claims, various modifications within the scope of the present disclosure are possible. Therefore, although the present disclosure has been specifically described through preferred embodiments and optional features, the modifications disclosed herein may be recorded by those skilled in the art, and such modifications and changes may be considered within the scope of the present disclosure.

The raw materials or reagents used in the examples and the comparative examples of the present disclosure are all purchased from major manufacturers in the market. Those without specifying the manufacturer or concentration are all analytically pure raw materials or reagents that can be obtained conventionally, and there are no special limitations as long as they can achieve the expected effect. The instruments and equipment used in the examples, such as the reactor and the circulation pump, are all purchased from major manufacturers in the market, and there are no special limitations as long as they can achieve the expected effect. If no specific technology or conditions are specified in the examples, it shall be carried out according to the technology or conditions described in the literature in the art or according to the specification of the product.

In the present disclosure, a reactor 1 specifically has the following structure: the reactor 1 has a slope with an angle of 10-30 degrees at the bottom, thereby facilitating removal of the generated ferric phosphate and carrying out sewage treatment. The volume of the reactor is 10-100 cubic meters, and there is correspondingly provided with a feeding port, a viewing window, and a motor position on the top. Inside the reactor, there is a stirring paddle 11 with a hybrid direction, which is equipped with three sets of branch blades in different directions: upper, middle, and lower branch blades. The set of upper branch blades 111 are distributed in a downward direction with an angle of 35-45 degrees; the set of middle branch blades 112 are distributed in an upward direction with an angle of 15-20 degrees; the set of lower branch blades 113 are distributed in an upward direction with an angle of 15-20 degrees. Inside the reactor, there is also a spoiler 12, which is a trapezoidal block arranged on the inner wall of the reactor. The thickness of the spoiler can be set according to actual needs, generally consistent with the thickness of the main rod of the stirring paddle. The bottom of the spoiler is parallel to the bottom of the stirring paddle, and the top of the spoiler is higher than the set of upper branch blades of the stirring paddle.

At the bottom of the reactor, there is a circulation material outlet 13, which is connected to a circulation pipeline 2 equipped with a circulation pump 3. On the top of the reactor, there is a circulation material inlet 14, which is connected to the circulation pipeline 2. The material liquid in the reactor 1 is delivered by the circulation pump 3 through the circulation pipeline 2 to achieve circulation.

Outside the reactor, there is a jacket or a coiler, through which the reactor can be heated by introducing steam or cooled by introducing ice water or cold water.

In the present disclosure, the preparation process involved in the reactor includes: dissolving a ferric salt solution of ferrous sulfate in water in a ferrous pool, pumping it to a settling tank for sedimentation and filtering it to obtain ferrous sulfate filtrate, and then dispensing it into a certain concentration of ferric salt solution.

In the present disclosure, the feed amount of the ferric salt solution is 750 kilograms, and the weight percentage of ferrous sulfate heptahydrate in the ferric salt solution is 21.7%. The feed amount of monoammonium phosphate solution is 445 kilograms, and the weight percentage of monoammonium phosphate in the monoammonium phosphate solution is 19.6%. The feed amount of aqueous ammonia is 49 kilograms, with a concentration of 20%. The feed amount of hydrogen peroxide is 60 kilograms.

### Example 1

A process for preparing ferric phosphate by mixing and stirring in a reactor with external circulation, comprises the following steps of:
adding the ferric salt solution, the monoammonium phosphate solution, the aqueous ammonia and the hydrogen peroxide into the reactor, subjecting the resulting mixed liquid to a preliminary reaction at 90° C. for 1.5 h; carrying out an external circulation reaction at 85° C. for 2 h after the completion of the preliminary reaction.

The stirring speed of the stirring paddle with the hybrid direction was 800 r/min, and the delivery speed of the circulation pump was 50 m³/h.

### Example 2

The ferric salt solution, the monoammonium phosphate solution, the aqueous ammonia and the hydrogen peroxide were added into the reactor, and the resulting mixed liquid was subjected to a preliminary reaction at 90° ° C. for 2 h; after the preliminary reaction was completed, an external circulation reaction was carried out at 90° C. for 3 h.

The stirring speed of the stirring paddle with the hybrid direction was 900 r/min, and the delivery speed of the circulation pump was 50 m³/h. The volume of the reactor was 80 m³.

### Example 3

The ferric salt solution, the monoammonium phosphate solution, the aqueous ammonia and the hydrogen peroxide were added into the reactor, and the resulting mixed liquid was subjected to a preliminary reaction at 95° C. for 1.8 h; after the preliminary reaction was completed, an external circulation reaction was carried out at 88° C. for 2.5 h. The stirring speed of the stirring paddle with the hybrid direction was 850 r/min, and the delivery speed of the circulation pump was 50 m³/h. The volume of the reactor was 80 m³.

### Comparative Example 1

In this comparative example, no circulation reaction was carried out (i.e., there is no corresponding circulation pipeline and pump arranged outside the reactor); the mixed liquid was subjected to a preliminary reaction at 90° C. for 1.5 h; after the preliminary reaction was completed, a reaction was carried out at 85° C. for 2 h. The remaining conditions were consistent with those in Example 1.

### Comparative Example 2

In this comparative example, no circulation reaction was carried out (i.e., there is no corresponding circulation pipeline and pump arranged outside the reactor); the stirring speed of the stirring paddle with the hybrid direction was 850 r/min. The remaining conditions were consistent with those in Example 1.

### Comparative Example 3

In this comparative example, no circulation reaction was carried out (i.e., there is no corresponding circulation pipeline and pump arranged outside the reactor); the stirring speed of the stirring paddle with the hybrid direction was 1200 r/min. The remaining conditions were consistent with those in Example 1.

For the above Examples 1-3 and Comparative Examples 1-3, the reaction material liquid after the reaction was subjected to post-treatment. After the reaction was completed, the reaction material liquid was filtered and washed multiple times, and the filter residue was sent to the slurry tank and was added pure water for high-speed dispersion and washing, and then filter-pressed again to obtain a ferric phosphate filter cake. After the ferric phosphate filter cake was washed and qualified, the filter cake was sent to the flash drier for flash evaporation to obtain ferric phosphate dihydrate. The water content before drying was about 45%, and the water content after drying was 1%. After flash drying, the ferric phosphate dihydrate was calcined in a rotary kiln to obtain anhydrous ferric phosphate.

The physical indexes and chemical composition of the ferric phosphate prepared in Example 1 and Comparative Examples 1-3 were tested, and the results were summarized in Table 1:

TABLE 1

| | | | | | Comparative | Comparative | Comparative |
|---|---|---|---|---|---|---|---|
| testing item | | | testing method | Example 1 | Example 1 | Example 2 | Example 3 |
| physical | particle | Dmin | Laser particle size | 0.2 | 0.4 | 0.3 | 0.41 |
| indexes | size | | analyzer | | | | |
| | (μm) | D10 | Laser particle size | 0.66 | 3.8 | 2.9 | 4.2 |
| | | | analyzer | | | | |
| | | D50 | Laser particle size | 2.2 | 11.4 | 8.95 | 6.73 |
| | | | analyzer | | | | |
| | | D90 | Laser particle size | 12.6 | 65.3 | 57.6 | 56.8 |
| | | | analyzer | | | | |
| | | D99 | Laser particle size | 38.8 | 113.7 | 103.4 | 98.5 |
| | | | analyzer | | | | |
| | | Dmax | Laser particle size | 59.9 | 150.1 | 125.3 | 119.8 |
| | | | analyzer | | | | |

| | | | | | | |
|---|---|---|---|---|---|---|
| | TD (g/cm³) | Tapped density | 0.75 | 0.63 | 0.65 | 0.71 |
| | | tester | | | | |
| chemical | BET (m²/g) | Dynamic specific | 8.56 | 7.59 | 6.98 | 4.53 |
| composition | | surface area tester | | | | |
| | P (%) | Quinoline | 20.75 | 19.95 | 20.86 | 21.02 |
| | | phosphomolybdate | | | | |
| | | gravimetric method | | | | |
| | Fe (%) | Oxidation-reduction | 36.56 | 37.21 | 36.91 | 37.12 |
| | | titration | | | | |
| | Fe/P | Calculation | 0.987 | 1.044 | 0.981 | 0.979 |
| | Ca (ppm) | ICP | 2 | 20 | 15 | 21 |
| | Mg (ppm) | ICP | 99 | 105 | 106 | 101 |
| | Na (ppm) | ICP | 3 | 4 | 3 | 2 |
| | Ni (ppm) | ICP | 9 | 15 | 16 | 13 |
| | Zn (ppm) | ICP | 13 | 15 | 16 | 5 |
| | Cu (ppm) | ICP | 1 | 3 | 2 | 3 |
| | Mn (ppm) | ICP | 87 | 358 | 238 | 152 |
| | Pb (ppm) | ICP | 0 | 0 | 0 | 0 |
| | Cr (ppm) | ICP | 16 | 18 | 21 | 18 |
| | K (ppm) | ICP | 17 | 25 | 23 | 19 |
| | Co (ppm) | ICP | 2 | 4 | 3 | 2 |
| | Al (ppm) | ICP | 67 | 85 | 75 | 73 |
| | Mo (ppm) | ICP | 0 | 0 | 0 | 0 |
| | Ti (ppm) | ICP | 21 | 29 | 30 | 18 |
| | S (ppm) | ICP | 122 | 138 | 141 | 129 |
| | magnetical | magnetic material | 0.31 | 0.42 | 0.49 | 0.38 |
| | item (ppm) | tester | | | | |
| | pH | pH meter | 2.99 | 3.25 | 3.23 | 3.19 |
| | H₂0 (ppm) | Karl Fischer | 3065 | 4157 | 4201 | 3958 |
| | | Moisture Titrator | | | | |

From Table 1, by comparing the quality of the ferric phosphate obtained from Example 1 and Comparative Example 1, it can be seen that the weight of the ferric phosphate obtained from Example 1 was 1.4 times greater than that of the ferric phosphate obtained from Comparative Example 1. After testing the material liquid after the reaction in Comparative Example 1, it was found that there was considerable amount of unreacted ferric salt solution. By comparing the impurity between Example 1 and Comparative Examples 1-3, the content of the impurity in Example 1 was generally low, and the purity was correspondingly improved. The particle size in Example 1 was less than that in each of Comparative Examples 1-3, and the particles were relatively more evenly distributed, which can subsequently shorten the diffusion path of Li⁺ in Lithium ferric phosphate battery.

From Comparative Examples 1-3, it can be seen that without using the circulation pump, too slow stirring speed led to incomplete reaction of the materials. Correspondingly, accelerating the stirring speed resulted in a certain improvement in the tapped density of the materials, but to a certain extent, the specific surface area decreased, reflecting a decrease in porosity, which was unilaterally not conducive to the subsequent intercalation and deintercalation of Li⁺. Based on this difference, in contrast with comparative experiments, the present disclosure carried out the reaction accompanied by the external circulation in Example 1, resulting in a relatively uniform particle size. While high tapped density is ensured, the specific surface area can also be balanced, improving the energy density and electrochemical activity of the materials.

A system for preparing ferric phosphate by mixing and stirring in a reactor with external circulation, comprises a controller for executing the process of preparing ferric phosphate by mixing and stirring in the reactor with external circulation as described above. Those skilled in the art can understand that implementing all or part of the processes in the above embodiments can be accomplished by instructing the relevant hardware through existing controllers (computer programs). The computer programs can be stored in a non-volatile computer readable storage medium, and the computer program can include processes in the embodiments of the above methods when executed. Among them, any reference to memory, storage, database, or other media used in the embodiments provided in the present disclosure can include non-volatile and/or volatile memory. Non-volatile memory can include read-only memory (ROM), programmable ROM (PROM), electrically programmable ROM (EPROM), electrically erasable programmable ROM (EEPROM), or flash memory. Volatile memory can include random access memory (RAM) or external cache memory. As an explanation rather than limitation, RAM is available in various forms, such as static RAM (SRAM), dynamic RAM (DRAM), synchronous DRAM (SDRAM), dual data rate SDRAM (DDRSDRAM), enhanced SDRAM (ESDRAM), synchronous link DRAM (SLDRAM), Rambus direct RAM (RDRAM), direct memory bus dynamic RAM (DRDRAM), and memory bus dynamic RAM (RDRAM).

The above merely describes specific embodiments of the present disclosure. In addition, the present disclosure can also be implemented in other ways, and any obvious alternative is within the scope of protection of the present disclosure without departing from the concept of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A process for preparing ferric phosphate by mixing and stirring in a reactor with external circulation, comprising the following steps of:
adding a ferric salt solution, a monoammonium phosphate solution, and a protective agent into the reactor, and subjecting the resulting mixed liquid to a preliminary reaction at 90-100° C.; after the completion of the preliminary reaction, carrying out an external circulation reaction at 85-90° C.

2. The process for preparing ferric phosphate by mixing and stirring in the reactor with external circulation according to claim 1, wherein the time for the preliminary reaction is 1.5-2 hours.

3. The process for preparing ferric phosphate by mixing and stirring in the reactor with external circulation according to claim 1, wherein the time for the circulation reaction is 2-3 hours.

4. The process for preparing ferric phosphate by mixing and stirring in the reactor with external circulation according to claim 1, wherein a circulation pipeline is arranged outside the reactor, and a circulation pump is arranged on the circulation pipeline; and wherein by using the circulation pump, the mixed liquid is delivered from the reactor to the circulation pipeline, and then from the circulation pipeline to the reactor to form a circulation for external circulation reaction.

5. The process for preparing ferric phosphate by mixing and stirring in the reactor with external circulation according to claim 4, wherein one end of the circulation pipeline is connected to the bottom of the reactor, and another end of the circulation pipeline is connected to the top of the reactor, so that the mixed liquid in the reactor can be circulated through the circulation pump to flow out from the bottom of the reactor and enter the reactor from the top of the reactor.

6. The process for preparing ferric phosphate by mixing and stirring in the reactor with external circulation according to claim 4, wherein the stirring speed of the stirring paddle in the reactor is 800-900 r/min, and the delivery speed of the circulation pump is 50 m³/h.

7. The process for preparing ferric phosphate by mixing and stirring in the reactor with external circulation according to claim 6, wherein the stirring paddle in the reactor has a hybrid direction.

8. The process for preparing ferric phosphate by mixing and stirring in the reactor with external circulation according to claim 1, wherein the reactor has a slope at the bottom.

9. The process for preparing ferric phosphate by mixing and stirring in the reactor with external circulation according to claim 1, wherein the protective agent is hydrogen peroxide.

10. A system for preparing ferric phosphate by mixing and stirring in a reactor with external circulation, comprising a controller for executing the process of preparing ferric phosphate by mixing and stirring in a reactor with external circulation as claimed in claim 1.
